(19) United States
(12) Patent Application Publication
(10) Pub. No.: US 2023/0415237 A1
(43) Pub. Date: Dec. 28, 2023

(54) Shot Brush Depowdering

(71) Applicant: Desktop Metal, Inc., Burlington, MA (US)

(72) Inventor: Jonah Samuel Myerberg, Lexington, MA (US)

(73) Assignee: Desktop Metal, Inc., Burlington, MA (US)

(21) Appl. No.: 18/212,658

(22) Filed: Jun. 21, 2023

Related U.S. Application Data
(60) Provisional application No. 63/354,534, filed on Jun. 22, 2022.

(51) Int. Cl. B22F 10/68; B22F 10/14; B22F 12/86; B33Y 10/00; B33Y 30/00; B33Y 40/20

(52) U.S. Cl. CPC B22F 10/68; B22F 10/14; B22F 12/86; B33Y 10/00; B33Y 30/00; B33Y 40/20; B22F 2998/10

(57) ABSTRACT

A method of de-powdering green parts manufactured via binder jetting additive manufacturing. First, a bulk de-powdering operation is conducted on the green part. Next, a fine de-powdering operation is conducted on the green part. The fine de-powdering operation includes disposing the green part within a bed of shot brush de-powdering media and agitating the bed of shot brush de-powdering media to remove from at least one surface of the green part an amount of build material powder.

### CROSS REFERENCE TO RELATED APPLICATION

The present application claims priority to U.S. Provisional Patent Application No. 63/354,534, filed Jun. 22, 2023.

### BACKGROUND

3D printing, a form of additive manufacturing, is poised to revolutionize manufacturing if production speeds can be significantly increased. Binder Jetting offers a path to significantly faster 3D printing, if all aspects of the printing process can be automated. Currently, automation of all parts of the binder jetting process have been demonstrated (powder preparation, printing, drying, sintering), except for part de-powdering.

Binder jetting 3D Printing can very rapidly produce large quantities of complex green parts, but due to the fragile nature and agnostic geometry of these green parts, excavating them from their build boxes and removing all of the loose powder prior to sintering can take significant time and manual handling. Typically the de-powdering task is split into two method sections: 1) bulk de-powdering or removing the part from the build box; and 2) fine de-powdering or removing all of the unbound powder from the surfaces of the printed parts.

Even with robots moving and removing loose powder from around printed green parts and retrieving parts out of build boxes automatically (task 1, above), bulk de-powdering is relatively simple. Removing all of the un-bound powder from all of the surfaces and crevices of a part's complex geometry is often the most time consuming. Typically, compressed air is utilized to blow build material powder off surfaces, but high pressures can damage surfaces or break parts. Air alone, even at high pressure, is often not enough to fully clean a surface, and brushes are used to contact the surface and physically sweep away unbound build material powder. It turns out that this type of contact cleaning method is critical to the success of fine de-powdering in the Binder Jet 3D printing process.

### SUMMARY

Disclosed is a method of automating de-powdering. Shot-brush de-powdering media is moved relative to and against green parts manufactured via binder jetting additive manufacturing to cleanse the green parts of excess build material powder so that the green parts can then be sintered without contamination.

### BRIEF DESCRIPTION OF THE DRAWINGS

The criticality of the features and merits of the present application will be better understood by reference to the attached drawings. It is to be understood, however, that the drawings are designed for the purpose of illustration only and not as a definition of the limits of the present invention.

FIGS. 1A-B depict a green part manufactured via binder jetting additive manufacturing and subject to a bulk de-powdering operation.

FIG. 2 depicts a first embodiment shot brush de-powdering system.

FIG. 3 depicts a second embodiment shot brush de-powdering system.

FIG. 4 depicts a third embodiment shot brush de-powdering system.

### DETAILED DESCRIPTION

Disclosed is a method of contact-based fine de-powdering called “shot brush de-powdering” that is aggressive enough to remove loose powder bound to the surface of printed green parts, gentle enough not to damage the surface or the delicate complex geometry of the printed green part, and easily automatable. This de-powder process may be understood to occur in a de-powdering system. For the purposes of this application, a green part should be understood to refer to a pre-sintering part formed from a build material powder bound by a binder jetted from an additive manufacturing system in successive layers.

Shot Brush de-powdering may consist of creating a packed bed of small, loose, smooth media, and exciting the bed with energy, fluidizing the media to get the particles moving and bouncing off each other, and then passing the part to be de-powdered through this fluidized bed of media.

The size of the media in shot brush de-powdering is critical in order for all the media to reach into small crevices on the part, contact the loose particles of build material powder, and brush it off the surface of the part. In binder jetting additive manufacturing the average build material powder particle size is usually 1-100 um in diameter, and features of printed parts are usually 0.5 mm-5 mm in size, so a good size for shot brush de-powdering media is 0.5 mm-1 mm in diameter. The process ends up mixing the loose build material powder with the cleaning media, so having a difference of 10-1000× particle size is also advantageous for separating the particles after cleaning, such as through classification or sieving.

In certain embodiments, the size of the shot brush media may be tuned with respect to the size of the excess build material powder present on the surface of the printed green parts. In certain embodiments, it may be desirable for the shot bush media to exhibit a size much larger than the build material powder particles from which the green part is comprised, in such an embodiment the shot blast media may be easily separable from the excess build material powder by use of a sieve, cyclone separator, or similar separation apparatus as will be familiar to one skilled in the art. In certain embodiments, it may be desirable to have the excess build material powder of a size which is much smaller than the powder from which the green part is comprised in such an embodiment, the excess build material powder may then be easily separable from the shot brush media via use of a sieve, cyclone separator, or similar separating apparatus as will be familiar to one skilled in the art.

In certain embodiments, the smoothness, shape, or angularity of the shot brush de-powdering media may be an important factor in the performance of the de-powder process. In certain embodiments, it may be desirable for the shot brush media to be a dense and smooth particle, such as a sphere of size between 0.25 and 1 mm diameter. Depending upon the agitation chosen for the de-powder mechanism, particles of such as size and density will transmit a certain energy to the surface of the green part during the de-powdering process. The energy transmitted may be selected to abrade loose build material powder from the surface of the printed green parts, while remaining under a threshold amount of energy where the parts may become damaged.

In certain embodiments, it may be desirable for the shot brush de-powdering media to be angular, fibrous, or otherwise non-equiaxed. In certain embodiments, a material such as bits of sponge, plastic, rubber, or the like may be used. For the case of angular sponge or rubber, the density may be much lower than the printed green part (the sponge or rubber at 1 g/cc or less, while the part may be between 4 and 6 g/cc); while the size and density of the shot de-powdering media may be very different than the density of the green part, the angular form of the shot de-powdering media is selected to encourage scraping and other interactions of increased friction between the part and the shot de-powdering media which may encourage the removal of loose powder. Further, the low density of the shot brush de-powdering media may result in decreased damage to the printed objects.

In certain embodiments, it may be desirable for the shot brush de-powdering media to be of a different magnetic nature from the build material powder to allow for ease of separation and recovery of build material powder from the shot brush de-powdering media. For example, in the case of a magnetic build material powder (e.g. most steels, stainless steels, and other iron alloys), a non-magnetic shot brush de-powdering media may be selected. By way of further example, shot brush de-powdering media which is magnetic in nature may be selected for non-magnetic build materials (e.g. alloys of copper, alloys of nickel, certain stainless steels, precious metals, and the like). When the de-powdering process is complete, the difference in magnetic properties may be used to separate the de-powdered green parts from the shot brush de-powdering media, for example by using a magnet to extract magnetic parts from a non-magnetic shot brush de-powdering media. Further, the difference in magnetic properties may also be used to separate and collect the excess build material powder which was cleaned from the part.

The shape of the media in shot brush de-powdering is critical in order to not damage the part being de-powdered or stick the media to features of the part. Smooth, polished, spherical media is an example of media that is appropriate for shot brush de-powdering. This shape of media is not overly aggressive so that the bound powder part is not damaged, and the shot brush de-powdering media flows and moves around easily so the right amount of energy can be applied into the fluidization process.

In addition to the selection of the shape of the shot brush de-powdering media to purposefully avoid affecting the surface of the objects in de-powdering, it may be advantageous, in certain embodiments, to select a shot brush de-powdering media and also a strength (or intensity) of agitation to provide some degree of surface modification to the objects subjected to de-powdering. In certain embodiments, the shot brush de-powdering media may be selected to gently smooth the surfaces of the objects in the de-powdering process. While not to be bound by theory, the interaction between green parts and shot brush de-powdering media may serve to remove high points by abrasion or by compressing the surface similar to a shot peening process.

The density of the shot brush de-powdering media is important also in order to store and deliver energy into the brushing and de-powdering process. Generally, 0.9-9 g/cm 3 is a good working range for materials that can deliver enough de-powdering energy without damaging the part surface.

The density of the shot brush de-powdering media may further be important. In certain embodiments, it may be desirable for the shot brush de-powdering media to exhibit a higher density than the density of the printed green part, while in other embodiments it may be desirable for the shot brush de-powdering media to exhibit a lower density than the density of the printed green part. In instances where the density of the shot brush de-powdering media is larger than the density of the green part, the green part may be forced to float or flow to the free surface of the shot brush de-powdering media which may be advantageous for removal of the green part from a chamber, vessel, or other container used for shot brush de-powdering. In instances where the shot brush de-powdering media is of a lower density than the printed green part, the green part may be forced to sink toward a bottom (or any other direction aligned with the direction of gravitational or maximal acceleration) of a chamber, vessel, or other container used for shot brush de-powdering.

In certain embodiments, a shot brush de-powdering media material such as a bicarbonate may be used. Materials of this class may be readily dissolved in water. In certain embodiments, a shot brush de-powdering media material such as a dry ice (solid carbon dioxide) of a fine size (perhaps in the range from 0.1 to 1 mm) may be used. Materials of the dry ice class may readily evolve to a gas facilitating the separation between the printed green part and the shot brush de-powdering material.

Shot brush de-powdering can be automated by creating a continuous fluidized bed, energized in a way that when the part is placed into the bed it moves the part forward through the de-powdering process, dwelling it within the shot brush de-powdering media long enough to de-powder the surfaces, but not too long to damage the surfaces, and then automatically separating the shot brush de-powdering media from the green part through a sieving type of process, allowing the part to be picked up and moved into the sintering process and allowing the media to recycle back to the beginning and be reused. The fine build material powder that is removed from the green part's surface is significantly smaller than the shot brush de-powdering media and will naturally migrate to the bottom of the fluidized bed. This allows this build material powder to be removed and recovered by a separate but integrated sieving process at the bottom of the bed.

The fluidized bed described above can be achieved through any number of means, such as vibration, airflow, waterfall, etc, and parts can be automatically fed through this fluidized media any number of ways, such as within a basket, hanging from a rack, vibration, etc.

In certain embodiments, it may be desirable to control the environmental conditions (e.g., humidity, temperature, etc.) within the de-powdering chamber, in which the objects undergoing de-powdering and the shot brush de-powdering media, are contained. By controlling the environmental conditions within the de-powdering chamber, the flow characteristics of the de-powder media may be affected. In certain embodiments, a decrease in humidity may be desired to decrease cohesive interactions between objects in the de-powdering system. In certain embodiments, an increase in humidity may be desired to increase cohesive interactions between objects in the de-powdering system.

With regard to temperature, the heating and cooling of the green parts undergoing de-powdering and the shot brush de-powdering media may have different effects on the de-powdering process and may be desired to be changed from a normal temperature of the room. For example, in certain embodiments, it may be desirable to heat or cool the objects undergoing de-powdering such that the mechanical properties of the objects will be affected by the change in temperature, leading to, for example, a decrease in breakages or other defects that may occur in the powder bed. In certain embodiments, it may be desirable to cool certain components (parts and/or some or all of the de-powdering media) using liquid nitrogen, argon, or other material which will vaporize to a gas at room temperature. In certain embodiments, it may be desirable to use a solid such as dry ice (carbon dioxide) as both a de-powdering material and a material to control, modify, or otherwise affect the temperature of the de-powdering system.

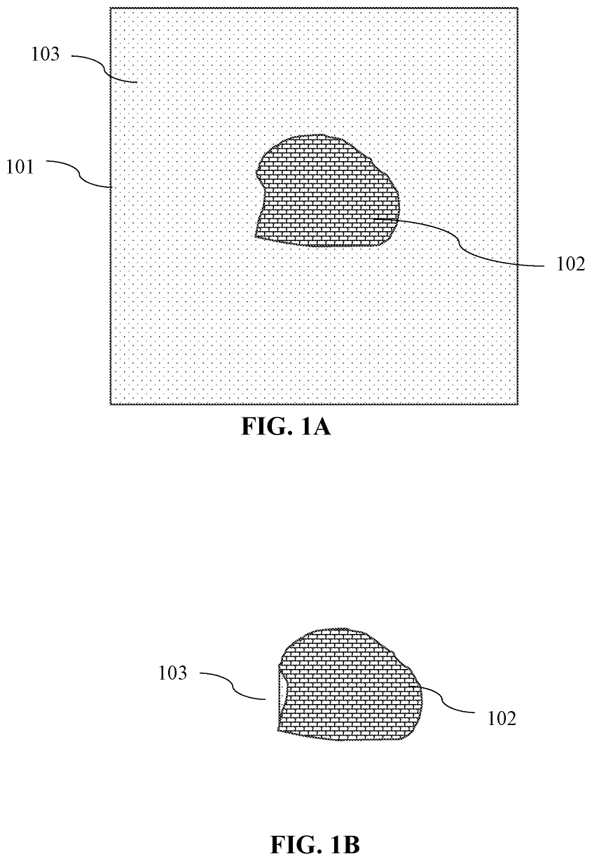

FIGS. 1A-B depict an exemplary build box 101 having constructed in it via binder jetting additive manufacturing a green part 102, surrounded by loose build material powder 103. During binder jetting additive manufacturing, successive layers of binder are jetted onto newly deposited layers of build material powder to bind the build material powder. Often, after jetting on metal build material, the resultant part is considered a green part as it needs to be sintered in a sintering furnace to densify the green part into a final product. FIG. 1B depicts the green part 102 after a bulk de-powder operation, which may for example be simply emptying the build box, vacuuming most of loose build material powder 103, or mechanically extracting the green part 102. As depicted in FIG. 1B, after the bulk de-powder operation, there will remain some amount of loose build material powder 103 stuck to the surface of the part 102 or filling in features of the part 102. This powder may be considered a contaminant in that the part 102 needs to be free of it to proceed to sintering.

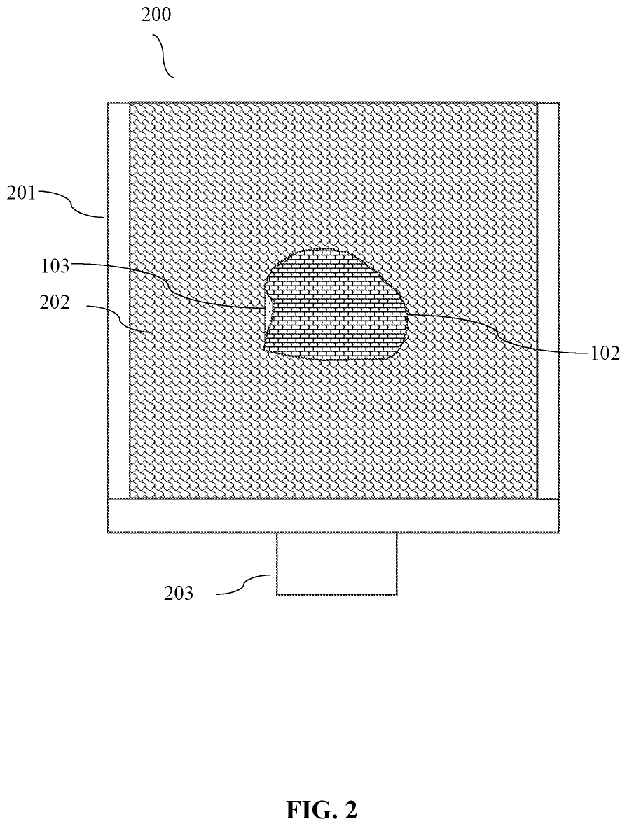

FIG. 2 depicts a first embodiment shot brush de-powdering system 200. A container housing 201 contains an amount of shot brush de-powdering media 202. An agitation system 203 is configured to agitate the shot brush de-powdering media 202, such as by vibration, whereby the shot brush de-powdering media is fluidized and acts against the loose build material powder 103 to dislodge it from the green part 102.

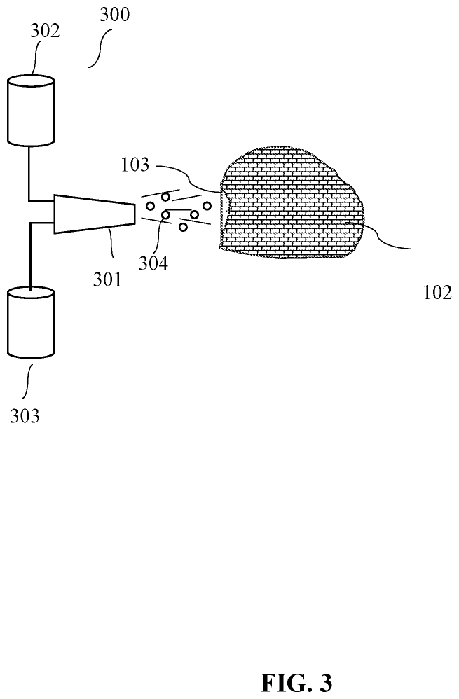

FIG. 3 depicts a second embodiment shot brush de-powdering system 300. A nozzle system 301 combines a shot brush de-powder media from a media source 302 with a compressed gas, such as air, from a gas source 303 and ejects shot brush de-powder media 304 against the green part 102 to dislodge loose build material powder 103.

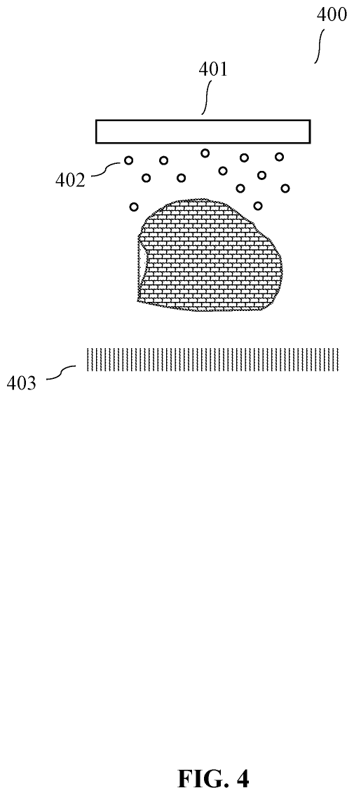

FIG. 4 depicts a third embodiment shot brush de-powdering system 400. A dispenser 401 ejects a flow of shot brush de-powdering media 402 via gravity. A collector 403 is configured to collect the shot brush de-powdering media 402 and may in certain embodiments recycle it for reapplication. The collector 403 may also separate build material powder from received shot brush de-powdering media.

Described now are some exemplary shot-brush de-powder media.

A first shot de-powdering media is SPHERE SHOT® from Maxi-Blast Inc. having a principal place of business in South Bend, Indiana. This is a spherical engineered plastic. This product has the following specifications:

| Part Designation | Sieve Size | Inches | Millimeters |
|---|---|---|---|
| PB-1 | 18/30 | .039/.024 | 0.99/0.61 |
| PB-2 | 30/45 | .024/.014 | 0.61/0.36 |
| PB-2.5 | 35/45 | .020/.014 | 0.50/0.36 |
| PB-3 | 45/100 | .014/.006 | 0.36/0.15 |
| PB-4 | 60/100 | .010/.006 | 0.25/0.15 |

A second shot de-powdering media is AMACAST™ 300-Series cast stainless steel shot from Ervin Industries, Inc. having a principal place of business in Ann Arbor, Michigan. Such shot may have a chemical composition of: Chromium 16-20%, Nickel 6-10%, Silicon <3% and Manganese <2%.

A third shot de-powdering media is a grounded corn cob for instance of the following specifications:

| | |
|---|---|
| Size | Mesh |

| | | |
|---|---|---|
| 4-3.15 | mm | 6# |
| 2.0-1.5 | mm | 12# |
| 1.5-1.18 | mm | 16# |
| 1.18-0.71 | mm | 20# |
| 0.71-0.50 | mm | 30# |

A fourth shot de-powdering media is crumb rubber.

Example vibratory machines that may be suitable for repurposing for integration with embodiments of the present disclosure include round bowl vibratory equipment as made my Almco having a principal place of business in Albert Lea, Minnesota.

What is claimed:

1. A method of de-powdering, comprising the steps of:
disposing in a de-powdering area an additively manufactured green part having at least one surface contaminated with an amount of build material powder; and
moving an amount of shot brush de-powdering media relative to and against the at least one surface of the additively manufactured green part to dislodge the build material powder.

2. The method of claim 1 wherein the movement of the amount of shot brush de-powdering media includes submerging the additively manufactured green part in the shot brush de-powdering media and agitating the shot brush de-powdering media.

3. The method of claim 1 wherein the movement of the amount of shot brush de-powdering media includes subjecting the additively manufactured green part to a gravity fed flow of the shot brush de-powdering media.

4. The method of claim 1 wherein the movement of the amount of shot brush de-powdering media includes subjecting the additively manufactured green part to a gas powdered flow of the shot brush de-powdering media.

5. The method of claim 1 wherein the shot brush de-powdering media has a material density greater than a material density of the green part.

6. The method of claim 1 wherein the shot brush de-powdering media has a material density less than a material density of the green part.

7. The method of claim 1 further comprising the step of, during moving the amount of shot brush de-powdering media, increasing a humidity of the de-powdering area.

8. The method of claim 1 further comprising the step of, during moving the amount of shot brush de-powdering media, decreasing a humidity of the de-powdering area.

9. The method of claim 1 wherein an average dimension of the shot brush de-powdering media is at least 0.5 mm.

10. A method of de-powdering, comprising the steps of:
manufacturing a green part via binder jetting additive manufacturing;
conducting a bulk de-powdering operation on the green part;
conducting a fine de-powdering operation on the green part;
wherein the fine de-powdering operation includes the steps of:
disposing the green part within a bed of shot brush de-powdering media;
agitating the bed of shot brush de-powdering media and thereby removing from at least one surface of the green part an amount of build material powder.

11. The method of claim 10, further comprising a step of separating the build material powder from the shot brush de-powdering media.

12. The method of claim 10 wherein the step of disposing the green part within the bed of shot brush de-powdering media includes traversing the green part via a continuous conveyance system.

13. The method of claim 10 wherein the step of manufacturing the green part via binder jetting additive manufacturing includes jetting a binder on metal build material powder.

14. The method of claim 10 wherein the shot brush de-powdering media is non-magnetic and the green part is magnetic.

15. The method of claim 10 wherein the shot brush de-powdering media is magnetic and the green part is non-magnetic.

16. The method of claim 10 wherein an average dimension of the shot brush de-powdering media is selected according to a resolution of the green part.

17. The method of claim 10 wherein an average dimension of the shot brush de-powdering media is at least 0.5 mm.

18. A system for de-powdering, comprising:
a conveying system configured to traverse an additively manufactured green part contaminated by build material powder to a de-powdering area and submerge the green part in a shot brush de-powdering media; and
an agitation system configured to agitate the shot brush de-powdering media to substantially remove the build material powder from the green part.

19. The system of claim 18 wherein the conveying system is configured to eject the green part after the shot brush de-powdering media removes the build material powder.

20. The system of claim wherein an average dimension of the shot brush de-powdering media is at least 0.5 mm.
